(19) United States
(12) Patent Application Publication
(10) Pub. No.: US 2004/0114591 A1
(43) Pub. Date: Jun. 17, 2004

(54) IP Routing Between Modules on a PLC Backplane

(75) Inventors: Ronald H. Naismith, North Andover, MA (US); Thomas Godicke, Valbone (FR); Francois Gorisse, Mougins (FR); Jean-Jacques Genin, Nice (FR)

Correspondence Address: SQUARE D COMPANY, INTELLECTUAL PROPERTY DEPARTMENT, 1415 SOUTH ROSELLE ROAD, PALATINE, IL, 60067, US

(73) Assignee: SCHNEIDER AUTOMATION SAS, Sophia Antipolis Cedex (FR)

(21) Appl. No.: 10/605,442

(22) Filed: Sep. 30, 2003

Related U.S. Application Data
(63) Continuation-in-part of application No. 09/902,748, filed on Jul. 12, 2001.

(30) Foreign Application Priority Data
Jul. 13, 2000 (FR) 00 09803

(51) Int. Cl. H04L 12/28

(52) U.S. Cl. 370/389

(57) ABSTRACT

The present invention relates to a communications system in a programmable controller comprising smart modules, a network module connected to a TCP/IP network and an internal communications bus, for example the backplane bus connecting all the modules of the programmable controller with each other. The communications system enables exchanges of information in compliance with the TCP/IP protocol, to be performed on the internal communications bus. Each smart module has its own IP address and a TCP/IP stack. The communications bus includes several separate communications channels providing for simultaneous flow of the frames complying with the TCP/IP protocol together with frames complying with other protocols. The invention also relates to a programmable controller capable of implementing such a communications system.

### CROSS REFERENCE TO RELATED APPLICATIONS

This application is a continuation-in-part of U.S. patent application Ser. No. 09/902,748, filed on Jul. 12, 2001, entitled “Controller internal bus supporting the TCP/IP Protocol”, which claims priority to French patent application 00 09803, filed on Jul. 13, 2000. This application also incorporates U.S. patent application Ser. No. 09/477,108 entitled “Ethernet transfer device with an embedded programmable logic controller” by reference .

### DETAILED DESCRIPTION

The present invention relates to a communications system in a programmable controller (PLC) enabling exchanges to be performed on the internal communications bus of the programmable controller, complying with the TCP/IP protocol. The invention also relates to a programmable controller capable of implementing such a communications system. This system may be applied to any automated process and notably to the field of industrial automatisms, building automatisms or those for monitoring/controlling electrical distribution networks.

The IP (Internet Protocol) standard protocol defines an interconnection protocol between different communications networks, at the network layer level. The TCP (Transport Control Protocol) standard protocol defines, at the transport layer level, a robust and reliable transport mechanism for data ensuring data checking from one end to the other. Both of these protocols are used in global networks of the Internet, Intranet or Extranet type, which are combined in the present discussion under the term “TCP/IP network”.

A modular programmable controller controlling a process to be automated includes at least a central processing unit module on which runs an application program for monitoring/controlling the process. The programmable controller may also include, if need be, one or more job modules also provided with a processing unit for ensuring the automatism functions (weighing, regulation, positioning, communications, . . . ) as well as other modules such as (digital or analog) input/output modules. In the following discussion, the term “smart module” will indifferently represent a central processing unit module, a job module or any module provided with its own processing unit. The modules of a programmable controller are connected to each other by an internal communications bus, which is generally a bus of the back plane type. The protocols used on an internal communications bus are usually proprietary protocols.

It is known that a programmable controller may have a communications module, hereafter called network module, connected to the internal communications bus of the controller and connected to a TCP/IP network. Such a network module may then serve as a gateway between the TCP/IP protocol used on the TCP/IP network on the one side and one or several protocols implemented on the internal communications bus of the controller on the other side. A smart module of the controller connected to the internal communications bus, for example the central processing unit module, may thus gain access to the TCP/IP network through the gateway of this network module.

However, under these conditions, it is impossible to maintain the features of a communication according to the TCP/IP protocol from one end to another between two entities which communicate with each other. Indeed, the gateway formed by a network module cuts the TCP data flow and no longer provides the transparency of IP. The performance, reliability and transparency advantages provided by the TCP/IP protocol are thus lost. Now, it would be advantageous of being able to benefit from this standard protocol for communications from or to smart modules of a programmable controller.

The object of the invention is therefore to provide smart modules connected to the internal communications bus of a programmable controller, with direct access to the TCP/IP protocol in order to perform exchanges between them and exchanges on a TCP/IP network, without having to resort to a gateway at the application layer level which may prove to be costly. Further, by means of the TCP/IP protocol, the central processing unit module or the job modules of a programmable controller may directly use web protocols and architectures as for example the UDP, HTTP, XML, WAP, FTP, SMTP, SNMP, DHCP, DNS standards, etc . . .

For this purpose, the invention describes a communications system in a modular programmable controller comprising several smart modules provided with their own processing unit and comprising an internal communications bus for connecting all the modules of the programmable controller with each other. The communications system is characterized by the fact that it enables exchanges of information complying with the TCP/IP communications protocol to be performed on the internal communications bus and by the fact that, for exchanging information with compliance with the TCP/IP communications protocol, a smart module of a programmable controller includes its own IP address and a TCP/IP stack which may be executed by the processing unit of the smart module. Further, a modular programmable controller may include at least a network module, connected to an external TCP/IP network, enabling an smart coupler of the programmable controller to directly perform on the TCP/IP network, exchanges of information complying with the TCP/IP communications protocol, via the internal communications bus.

Moreover, the communications bus includes several separate communications channels allowing the simultaneous flow of exchanges complying with the TCP/IP protocol with exchanges complying to other protocols such as input/output exchanges.

Other features will become apparent in the following detailed description with reference to an exemplary embodiment and illustrated by the appended drawings wherein:

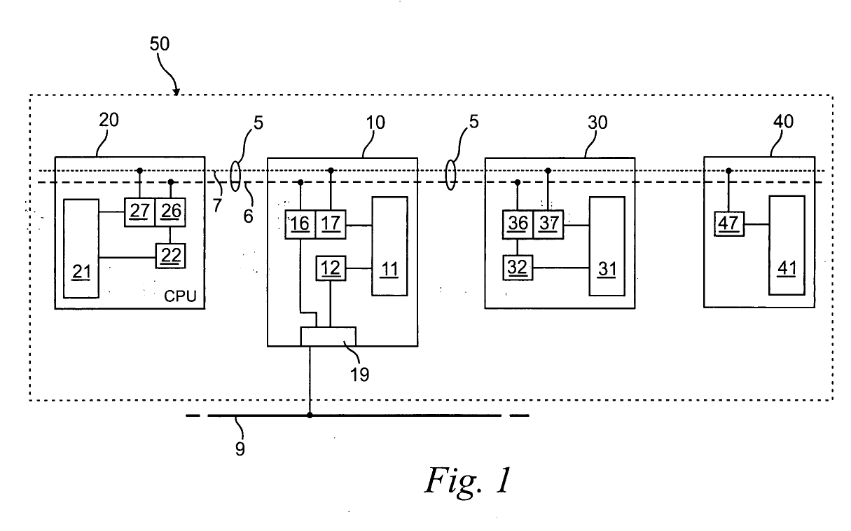

FIG. 1 illustrates an example of a basic architecture of a programmable controller provided with a communications system according to the invention and comprising a central processing unit, a network module, a job module and an input/output module,

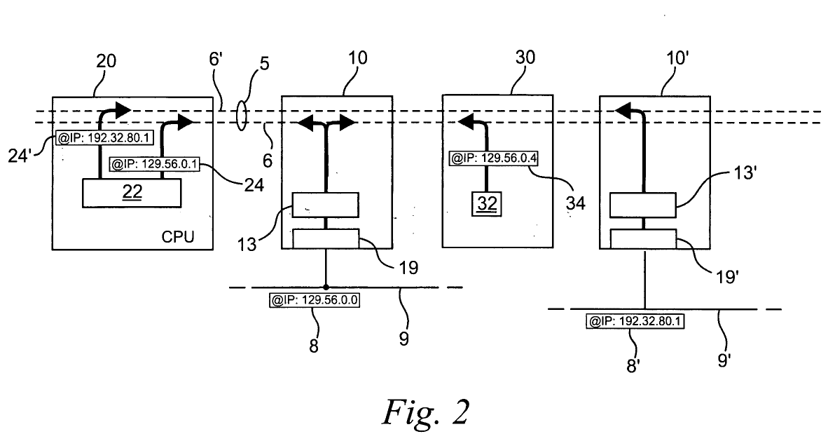

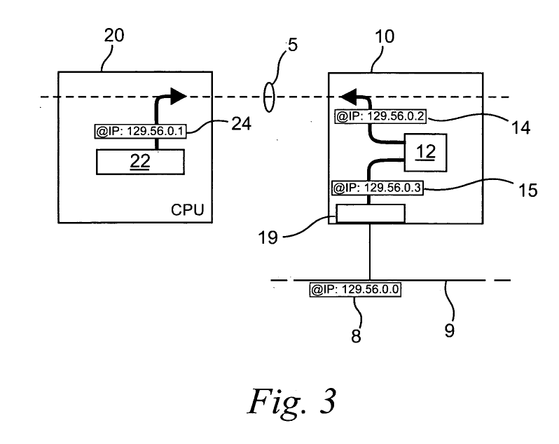

FIGS. 2 and 3 detail a first operating mode A and a second operating mode B of the communications system, respectively.

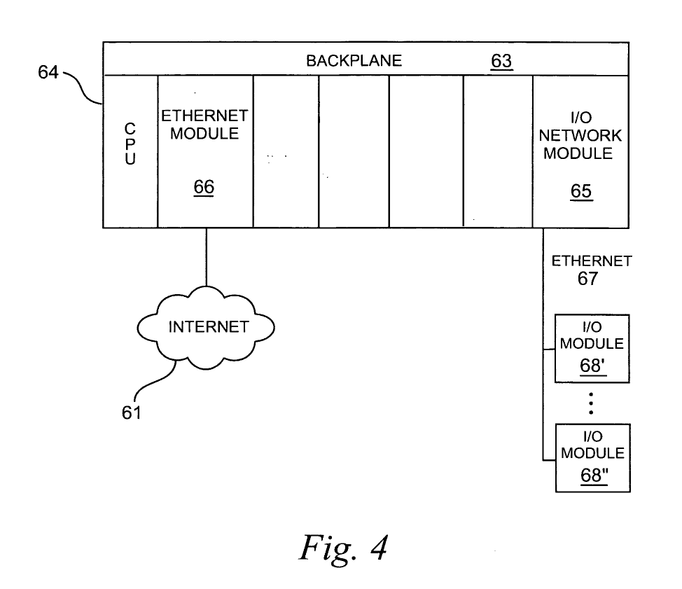

FIG. 4 illustrates the use of the routing of messages from a general network and an IO network.

In FIG. 1, a modular programmable controller 50, responsible for controlling a process to be automated, comprises a central processing unit module 20 (CPU), a network module 10, a job module 30, an input/output module 40 and an internal communications bus 5 connecting the different modules of the programmable controller 50 to each other. The number and the type of modules accepted in an controller 50 depend on the size and the power of this controller.

The central processing unit module 20 includes a processing unit 21 responsible for executing an application program for controlling the process. The central processing unit module 20 generally monitors the other modules of the programmable controller 5. A job module 30 includes its own processing unit 31, such as a microcontroller or a microprocessor, for performing one or more dedicated automatism functions, such as for example counting, communications, regulation, positioning, axis control, etc. An input/output module 40 is responsible for acquiring inputs from the process and for sending outputs to the process; in certain cases it may itself also have a simplified processing unit 41. The different modules 10,20,30,40 of the controller 50 may proceed with exchanges by means of an internal communications bus 5, which is generally the backplane bus of the controller.

The network module 10 has its own processing unit 11 and is connected to an external TCP/IP network 9 by means of an access driver 19 for the link layer and an adapter to the medium of the TCP/IP network 9 (non-schematized in FIG. 1) for the physical layer. Preferably, the TCP/IP network 9 is supported on the Ethernet standard for the physical and link layers, so that the access driver 19 notably handles MAC (Media Access Control) addressing of the network coupler 10, in compliance with the MAC link layer recommended in the IEEE802.3 standard or the RFC894 standard. As indicated at the beginning of the discussion, the TCP/IP network 9 uses the TCP/IP protocol at the network and transport layers. In the example of FIG. 1, the central processing unit module 20 and the job module 30 are smart modules able to communicate on the TCP/IP network 9.

The internal communications bus 5 should have the possibility of providing a flow of frames corresponding to the different communications fluxes: in addition to an IP communications flux linked to the TCP/IP protocol frames, an I/O data flux of the inputs/outputs of the controller and optionally other data fluxes linked for example to a proprietary messaging system actually exists on the communications bus 5. Accordingly, these fluxes are routed in the communications bus 5 on distinct communications channels which should operate at the link layer level and be capable of conveying any frame. A communications channel 6 for the IP flux and a communications channel 7 for the input/output I/O flux are illustrated in FIG. 1.

To connect to the communications bus 5, modules 10,20,30,40 include drivers for bus access, which handle the physical layer and the link layer of the communications bus and which should be specific to each communications channel. For the communications channel 7 corresponding to the I/O flux, modules 10,20,30,40 have an access driver 17,27,37,47. For the communications channel 6 corresponding to the IP flux, modules 10,20,30 have an access driver 16,26,36. The input/output module 40 with no access to the TCP/IP network 9 does not have any driver for accessing the IP flux.

The communications system enables smart modules 20,30 to communicate through the TCP/IP protocol either with each other, or directly on a TCP/IP network 9 connected to a network module 10. For this, the smart modules 20,30 each include a TCP/IP stack 22,32 which may be executed by the processing unit 21,31 of the smart module 20,30. This TCP/IP stack 22,32 is connected to the driver 26,36 for accessing the IP flux and handles the network and transport layers of the TCP/IP protocol. Each smart module 20,30 should also have its own IP address.

One method of assigning the IP addresses would include the use of a Private IP address for each smart module, with the backplane identifier as the least significant term of the address (i.e. 192.168.XX.YY where XX is a number for the PLC and YY is the number of the slot in the backplane).

Within a programmable controller 50, direct communication through TCP/IP between smart modules may be interesting for example when one of the modules is a HMI (Man-Machine Interface) coupler which exists as a HTTP navigator and which may natively exchange information according to the TCP/IP protocol. It may also communicate with smart modules of the controller without there being the need for developing other protocols.

Care must be taken to match the capabilities of the PLC backplane with the flexibility of the IP protocol. For instance, the IP frame MTU may need to be set to a small value to assure that the IP packets are small enough to fit the limitations of the backplane transfer units. Other information may have to be used to encapsulate the IP message so that the backplane drivers deliver the message to the proper board. In addition, the timing of message transfers must be managed to prevent or minimize the impact of transfers on the PLC scan or on other time critical functions of the PLC.

Two operating modes of the communications system will now be detailed, with reference to FIGS. 2 and 3:

In a first operating mode, functionally called A and detailed in FIG. 2, the communications bus 5 is only an extension of the TCP/IP network 9 to which the network module 10 is connected. In this case, the latter is only used for routing the IP frames transmitted or intended for a smart module 20,30. The network module 10 then does not have to include its own TCP/IP stack, except if it itself behaves as a smart module capable of having web applications.

For a smart module 20,30 of the controller to directly access the TCP/IP network 9 of a network module 10:

the TCP/IP stack 22,32 of the smart module 20,30 must be capable of transmitting and receiving frames with an encapsulation complying to the link layer (MAC layer) of the TCP/IP network 9,

each smart module 20,30 must have an IP routing table for routing the frames which it transmits, to the network module(s) 10,10′ of the controller 50,

the network module 10 must have filtering and redirection means 13 for the IP frames from the TCP/IP network 9, depending on the IP address 24,34 of the smart modules 20,30 so that only frames which include their IP address are sent to these modules 20,30. This filtering is possible by means of a table for storing the IP address of the smart modules 20,30 of the controller 50 which are able to access the TCP/IP network 9, wherein this storage table is stored in the network module 10.

In a second operating mode, functionally called B and detailed in FIG. 3, the communications bus 5 is seen as an integral IP sub-network of the TCP/IP network 9 to which the network module 10 is connected. In this case, the network module 10 includes two IP attachments materialized by a first IP address 15 corresponding to the TCP/IP network 9 and by a second IP address 14 corresponding to the communications bus 5 of the controller 50. The network module 10 also has necessarily its own TCP/IP stack 12 which may be executed in the network module 10, providing the routing of the frames between both IP attachments.

Depending on the IP sub-network address on the communications bus 5, it is possible to select the visibility level of a module on the TCP/IP network 9. If it is desired that the module be seen by Internet without any updating of an external router, the communications bus 5 must have an addressing including a same IP sub-network number as the TCP/IP network 9 of the network module 10, as is shown is FIG. 3. Further, the latter should act as a server proxy for a client proxy on the communications bus 5. As compared with the operating mode A, it is the coupler which answers to a MAC address acknowledgement request (ARP request on Ethernet).

As shown in FIG. 2, a same programmable controller may include several network modules 10,10′, each connected to a different TCP/IP network 9,9′, each having an IP network number 8,8′. In this case, the IP fluxes generated by each TCP/IP network 9,9′ are routed through separate channels 6,6′ on the communication bus 5. In order to be able to connect to these different Internet networks arriving on the controller 50, a smart module 20 should then have a specific IP address 24,24′ for each TCP/IP network 9,9′, respectively.

Taking into account the fact that, by means of the invention, a smart module 20,30 may be connected to the Internet directly, security aspects are important. A first security level is normally provided by an intranet firewall when the controller 50 is connected to an intranet type network 9. However, if better access control to the smart modules is desired, there are several possibilities: it is possible to add further filtering of the IP frames in the network module 10, a monitoring of the input connections above the TCP layer may be performed and it is also possible to abandon the server proxy behavior of the network module 10 in order to prevent a smart module 20,30 from being automatically seen by the outside world without any configuring of an external router, in the A and B operating modes. Moreover, both of these operating modes A and B are compatible with the RFC925 standard and the updating of the routing tables in an existing network is avoided. However, other scenarios could use the standard routing techniques of the Routing information Protocol (RIP) and the Open Shortest Path First (OSPF) protocol.

The communication system described in the present invention may be used by an application program of a programmable controller for communicating synchronization, monitoring, control data or any other information requiring the quality of the services provided by the protocols of the TCP/IP class. Further, an easy connection to the Internet and Web world is a major advantage as compared with proprietary protocols. Within such a programmable controller, an smart module (for example of the PC type) provided with an operating system and a commercial Internet navigator may thus be developed in order to form the man-machine operator dialog. The use of the TCP/IP protocol in a communications bus of an controller is also a preferred way for standardizing internal data exchange in a programmable controller, this standardization facilitating interoperability in an heterogeneous environment.

Similarly, data may be conveyed, which programmable automata do not usually use such as sound or video, this information may also be utilized by the application itself (a video capture module connected to a video processing module) or may be used by external applications or by services linked to the automatism (for example remote maintenance of an automatism installation).

The exchanged data may also be program code. These programs may be applications for changing the behavior of a module, for adding functionalities to it, for updating a software version, correcting an anomaly, spying it during development phases and for providing more specific remote maintenance services. This mechanism may thus provide the bases of a distributed processing architecture to the world of automatism.

Another possible architecture can be seen in FIG. 4. Here there is a network of 10 modules 68′, 68″ connected to an Ethernet subnetwork 67. These modules 68′, 68″, through the use of the herein described invention, can be monitored, configured, or diagnosed from a remote location through the Internet 61 via the PLC 64. The message traffic could be sent through a smart Ethernet module 66 connected to the Internet 61, into the PLC backplane 63, to the Ethernet module 65 that manages the 10 subnetwork 67, and to the 10 module 68′, 68″ on that subnetwork 67.

It is understood that without departing from the scope of the invention, other alternatives and detailed enhancements may be devised and the use of equivalent means may also be contemplated.

1. A programmable logic controller comprising:
a backplane of the programmable logic controller;
one or more modules connected to said backplane; said modules capable of communicating over said backplane using the IP protocol;
wherein each module has its own IP address.

2. The programmable logic controller of claim 1 wherein the IP address uses a local addressing schema.

3. The programmable logic controller of claim 2 wherein the local addressing schema is in a form of 192.168.XX.YY.

4. The programmable logic controller of claim 3 wherein a term XX in the addressing schema represents the number of the programmable logic controller.

5. The programmable logic controller of claim 3 wherein a term YY in the addressing schema represents a number describing a position in said backplane.

6. The programmable logic controller of claim 1 wherein the IP protocol is used in conjunction with a TCP protocol.

7. A method of communication between a first module and a second module on a programmable logic controller backplane comprising:
connecting said first modules to said programmable logic controller backplane wherein the first module is connected to a network of IO modules;
connecting said second module to said programmable logic controller backplane wherein the second module is connected to an Ethernet network;
communicating between said first module and said second module using the IP protocol, where the first module and the second module have their own IP address for backplane communications.

8. The method of communication of claim 7 wherein the Ethernet network is connected to an Internet.

9. The method of communication of claim 7 wherein an addressing schema for the IP address uses a local addressing schema.

10. The method of communication of claim 7 wherein the network of IO modules is an Ethernet network.

11. The method of communications of claim 7 wherein the IP protocol is used in conjunction with a TCP protocol.

12. An industrial automation system comprising:
at least one programmable logic controller that is capable of communicating messages to a backplane, wherein the messages are formatted using an IP protocol;
a first network module connected to said backplane that is also connected to an IO network; and
a second network module connected to said backplane that is also connected to an Ethernet network
wherein the programmable logic controller, the first network module, and the second network module each have their own IP address for backplane communications.

13. The industrial automation system of claim 12 wherein said Ethernet network is connected to an Internet.

14. The industrial automation system of claim 12 wherein the IP messages are addressed using a local addressing schema.

15. The industrial automation system of claim 12 wherein the IO network is an Ethernet network.

16. The industrial automation system of claim 12 wherein the IP protocol is used in conjunction with a TCP protocol.
